(19) United States
(12) Patent Application Publication
(10) Pub. No.: US 2008/0109290 A1
(43) Pub. Date: May 8, 2008

(54) Business model for interactive development of a product

(76) Inventors: Peter A. Marmentini, Westlake Village, CA (US); Scott Spector, Thousand Oaks, CA (US)

Correspondence Address: ALBERT O COTA, 5460 WHITE OAK AVE, SUITE A-331, ENCINO, CA, 91316, US

(21) Appl. No.: 11/983,300

(22) Filed: Nov. 8, 2007

Related U.S. Application Data
(60) Provisional application No. 60/864,933, filed on Nov. 8, 2006.

(51) Int. Cl. G06F 17/30

(52) U.S. Cl. 705/7

(57) ABSTRACT

A business model for interactive development of a product (10) that is comprised of a production facility (12), a website (16), a website host (18), a website access (20) and a revenue generator (24). The production facility (12) interfaces with the website (16) where choices pertaining to the product (10) are displayed. The general public utilizes the website access (20) to log onto the website. From the website the general public reviews the product choices and interactively submits their choices to the production facility. The choices are then used to assemble a final product (22) that is made available for distribution to the general public via the revenue generator (24).

This utility patent application claims priority of Provisional Patent Application No. 60/864,933 filed on Nov. 08, 2006.

### TECHNICAL FIELD

The invention generally pertains to the field of product development and more particularly to a business model that allows a product creator to interact with the public via an Internet website. The product creator and public provide inputs that are selectively. utilized by the product creator to develop a final product.

### BACKGROUND ART

During the last few years, reality-based television programs have proven to be some of the most successful developments in broadcast history. Audience participation game shows have also shown to be extremely popular, with some shows being on-the-air for many years.

One of the most significant reasons for these shows popularity is that the audience viewing from home feels a connection with tie participants on the shows. The home audience can relate to the participants as normal people, as opposed to film and television stars and critics. A home viewer may also personally low a participant, which substantially increases the personal connection.

Television producers have managed to increase the personal connection by often allowing a member of the home viewing audience to call-in or otherwise win a prize. For years radio stations have been keeping people listening to a particular radio station by simply allowing a to call-in and request a song. The person will generally continue listening at least until their requested song is played and then often thereafter because they feel that personal connection with the station that played their favorite song, just for them.

The basic fact is that by allowing a person to contribute to any facet of a creative process, will engender a personal connection between the person and the process or the outcome of the process. While reality-based television shows such as American Idol or Dancing with the Stars have provided the means by which a person can choose their favorite singer or dancer, they are still limited by several factors.

One of the most significant factors is that once the, audience has chosen a winner, the winner typically goes on and pursues his/her career or other interests. The audience can only remember that they voted for that person and helped them win during that shows particular season.

If it were possible to provide a person with the ability to actually assist in the creative process during the development of a product, the person would then have a permanent stake in the product. If the product is a song or movie, every time the person hears the song or sees the movie they will be reminded that they contributed to its creation. This will lead to a long-term association with a product or products, which in turn can result in substantial revenue generation from the sale and merchandising of the product or products.

A search of the prior art did not disclose any patents that read directly on the claims of the instant invention, however the following U.S. patents are considered related:

| PATENT NO. | INVENTOR | ISSUED |
|---|---|---|
| 6,746,246 | Cliff | 8 Jun. 2004 |
| 5,765,142 | Allred et al | 9 Jun. 1998 |

The 6,746,246 patent discloses songs that are defined by a song template comprising at least one track having a sequence of measures and a plurality of audio samples allocated to each track. At least two songs are played to an audience whose response indicates the popularity of each song.

The 5,765,142 patent discloses a customer service system interface development tool that is used, for creating an interface for customer interaction. The interface created by the development tool may be incorporated into a customer service system for presenting products or services to a customer for the customer to make a product or service selection. The interface tool includes modules for specifying global parameters relating to products or services that are presented to the customize and developing a profile of the customer service system environment in which the interface is to operate. An additional module aids in the planning of a presentation by associating data with the products or services available for presentation to the customer.

For background purposes and as indicative of the art to which the invention is related reference may be made to the remaining patents located in the search.

| PATENT NO. | INVENTOR | ISSUED |
|---|---|---|
| 5,753,843 | Fay | 19 May 1998 |
| 6,060,655 | Minamitaka | 9 May 2000 |
| 6,320,112 | Lotze | 20 Nov. 2001 |
| 6,404,893 | Iori | 11 Jun. 2002 |

### DISCLOSURE OF THE INVENTION

The business model for interactive development of a product is designed to assist a product creator to create a product that has as an ultimate goal to produce revenue. The assistance is provided in the form of creative inputs that are supplied by or submitted to the product creator by the general public via an Internet website. The product creator is free to utilize the creative inputs to produce a public selected final product.

In its basic configuration the inventive business model is comprised of:
a) a production facility having an interactive connection, and means for producing at least one review product and a final product:
b) a website having a first interactive connection, a second interactive connection, a third interaction connection and a fourth interactive output. The first interactive connection interfaces with the interactive connection on the production facility. The website provides choices pertaining to at least one review, product, and the ability to interactively select from the choices
c) a website host that is centrally located to control and manage the operation of the elements that comprise the business model,
d) a website access having an interactive connection that interfaces with the third interface connection on the website. The website access allows the public to log onto the website, view and hear at least one review product and the choices, interactively select from the choices, and view and hear the final product, and
e) a revenue generator having an input that receives the final product from said production facility via the website, and having means for generating revenue from the final product.

In view of the above disclosure, the primary object of the invention to provide a business model for interactive development of a product. The business model allows a product creator to interact with the public via an Internet website. A final product is developed based on creative input from the public or the creator and revenue is generated from sales of the final product as well as related merchandise and services.

In addition to the primary object of the invention, it is also an object of the invention to provide a business model that:

can be applied and utilized to produce a large number and variety of products,

can be utilized as the basis for a reality-based television show or a radio show,

when the product is a song/music, can assist the career of a major artist, new, artist or struggling artist(s),

allows individuals who do not possess creative skills to participate in the creative process of a product,

can be utilized to drive consumer and business traffic to a specific website(s), retail store(s), live music venue(s) or other related locations,

can be maintained at a constant level or can be grown to encompass a large number and variety of product's and services,

can be easily managed and cost maintained,

can allow both the general public and professional customers such as business-to-business (B2B) and business-to-customer(B2C), to interactively create a final product,

can provide a full music library (archive) of artists of every style, and

allows an individual to have a personal connection with a major artist, hit song or other successful product.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram showing a basic design configuration of the business model for interactive development of a product.

FIG. 2 is a block diagram showing a business model configuration that is applicable for the entertainment business and more particularly for the development of a song.

FIG. 3 is a block diagram showing the various products that can be processed by the production facility.

FIG. 4 is a block diagram showing the various products that are produced by the business model.

FIG. 5 is a block diagram showing the various revenue generating products.

FIG. 6 is a block diagram showing the various type of music that can be selected form studios or the website.

FIG. 7 is a block diagram of an overview configuration of the business model.

### BEST MODE FOR CARRYING OUT THE INVENTION

The best mode for carrying out the invention is presented in terms of a first and second embodiment for a business model for interactive development of a product 10, (hereinafter “business model 10”) is presented in terms of a first embodiment and a second embodiment. The first embodiment covers a basic design configuration that allows the business model 10 to produce a general product. The second embodiment covers a business model 10 that specifically covers a product that encompasses the entertainment field and in particular a song.

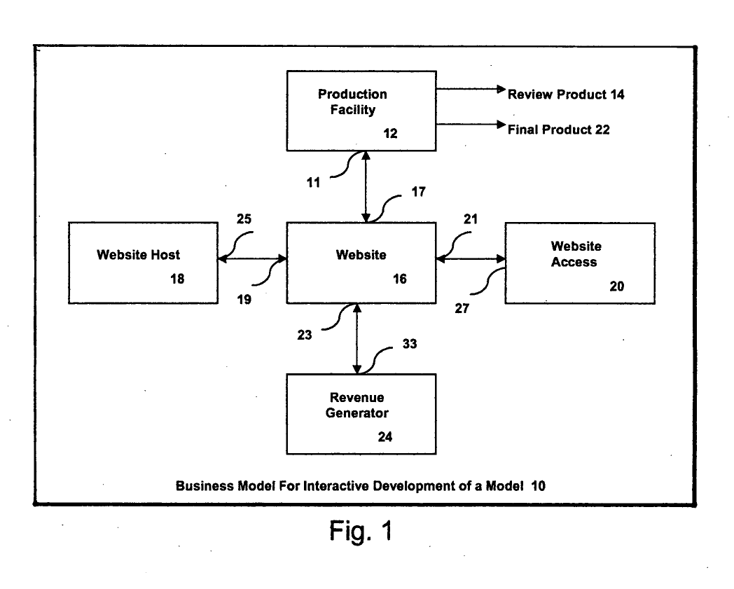

The basic design configuration of the business model 10, as shown in FIGS. 1, 3-5, is comprised of the following major elements a production facility 12, a website 16, a website host 18, a website access 20 and a revenue generator 24.

The production facility 12, as shown in FIG. 1, includes an interactive connection 11 and means for producing at least one review product 14 and a final product 22. The final product 22 is developed from inputs provided by an original product creator. and creative inputs that have been supplied to the product creator by the general public which can consist of individuals or a captive audience.

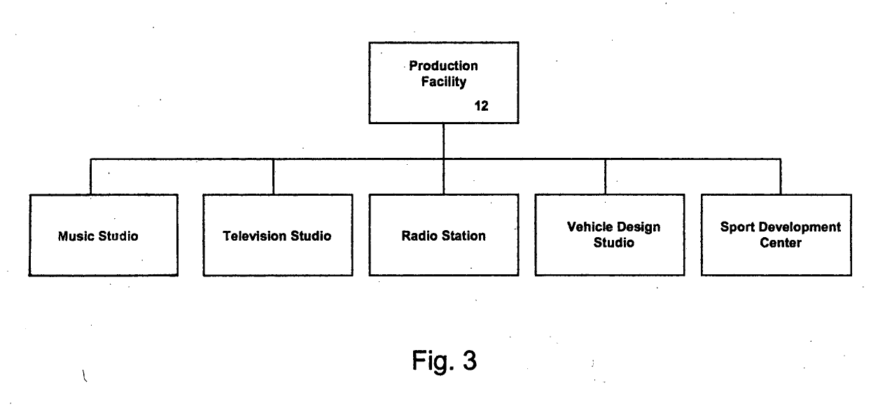

The production facility 12, as shown in FIGS. 1 and 3, is selected from the group consisting of, but not limited to, a music studio, a film studio, a television studio, a vehicle design studio, a radio station or a sport development center.

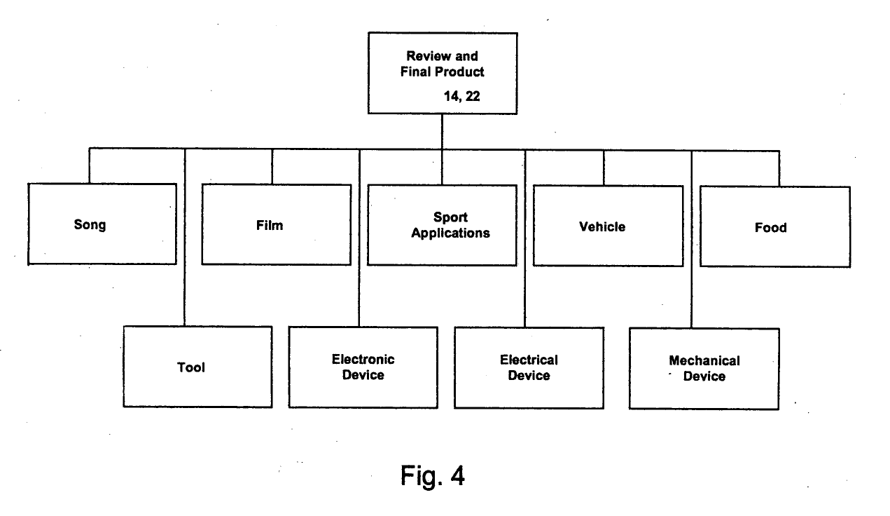

The review product, 14 and the final product 22; as shown in FIG. 4, are selected from the group consisting of, but not limited to, a song, a film, a sport application, a vehicle, a food and an article of manufacture that can be further selected from the group consisting of, but not limited to, a tool, an electronic device, an electrical device or a mechanical device.

When the product is a film, the choices can be selected from the group consisting of, but not limited to, major studios, independent studios, animation studios, writers, director, producers, visual effects companies, art directors, film directors, movie and stage stars and co-stars, music, dialogue and soundtracks of live-action films and animated films.

When the product is a vehicle, the choices are selected from the group consisting of, but not limited to, vehicle manufacturers, designers, design studios, consumer research companies, and new automotive designs and features; These vehicles choices are selected by viewing and evaluating their respective marketability and popularity, thereby helping to create the final automotive product.

When the product is a food, the choices are selected from the group consisting of but not limited to, food processors, restaurants, food television shows, gourmet chefs, growers, packaging companies, nutritionists, and food research laboratories. These foods are selected by viewing and evaluating their respective marketability and popularity, thereby helping to create the final food product.

The website 16, as shown in FIG. 1, has a first interactive connection 17, a second interactive connection 19, a third interactive connection 21 and a fourth interactive connection 23. The first interactive connection 17 interfaces with the interactive connection 11 located on the production facility 12. The connection 11, 17 is comprised of a digital data transfer protocol that is selected from the group consisting of a modem, dial-up service, broadband, broadcast, digital cable, fiber, mobile connection, satellite connection, set-top box, DVR or PVR.

The website 16 is designed to provide:

(1)choices pertaining to the at least one review product 14, and the ability to 10 select the choices,

(2) means for delivery of the final product 22, and

(3) means for storage and retrieval of the final product.

The website host 18, as shown in FIG. 1, has an interactive connection 25 that interfaces with the second interactive connection 19 that is located on the website 16. The website host is centrally located to control and manage the operation of the website 16.

The website access 20, as also shown in FIG. 1, has an interactive connection 27 that interfaces with the third interface connection 21 on the website 16, wherein the website access 20 allows the public to log onto the website 16 and is designed to provide the ability to:

(1) view and hear at least one review product 14 and the included choices,

(2) interactively select from the choices, and

(3) view and/or listen to the final product 22.

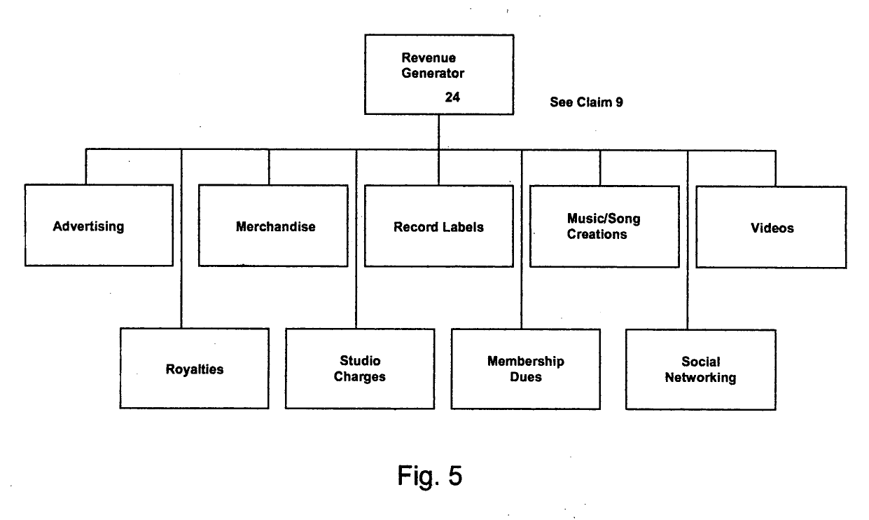

The final element that comprises the business model 10 is the revenue generator 24, as shown in FIGS. 1 and 5. The revenue generator 24 has an input-connection 33 that interfaces with the output connection 31 located on the final product 22. As shown in FIG. 4, the means for generating revenue is selected from the group consisting of, but not limited to, the sale of advertising web space, merchandise revenue sharing, sales of music or videos, record labels, studio charges, music/song creation revenue sharing, social networking and royalties.

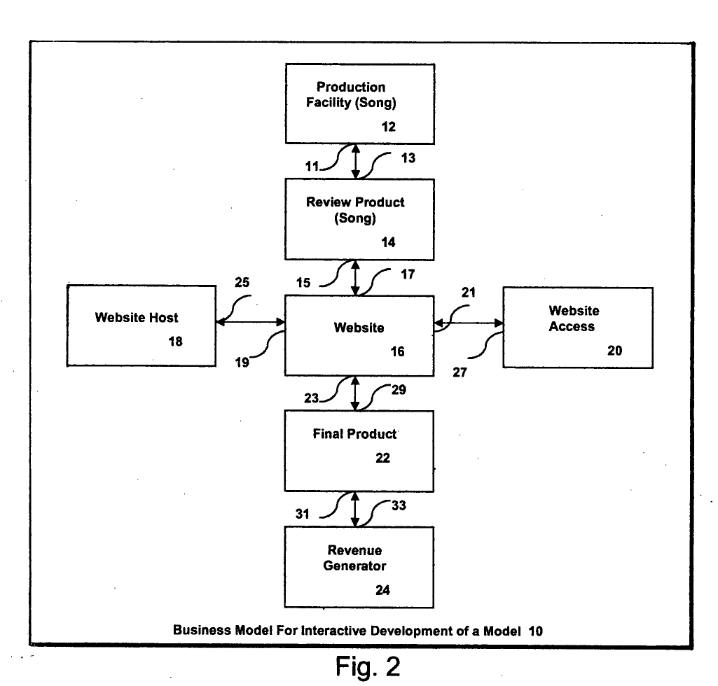

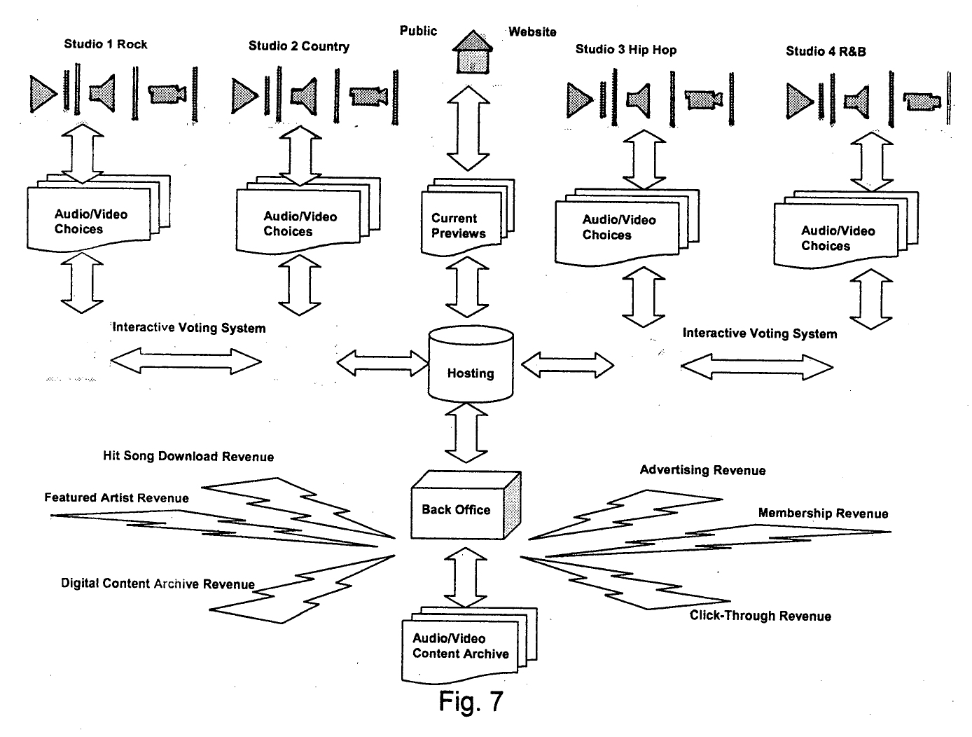

The second embodiment of the business model 10, as shown in FIGS. 2-6, is comprised of the following major elements: a production facility 12, a review-product 14, a website 16, a website host 18, a website access 20, a final product 22 and a revenue generator 24. An overview of the business model 10 is also shown in FIG. 7.

The production facility 12 in the second embodiment, as shown in FIG. 2, has an interactive-connection 11 and the ability to produce a plurality of elements that pertain to a song. The production facility 12 is designed to initially produce at least one review song 14 and eventually to develop and produce a final song 22.

The song production facility 12, as shown in FIG. 3, is comprised of but not limited to, a music studio for the production of rock, country, hip hop, R&B and classical music, a television studio or a live event venue.

The review song 14 has a first interactive connection 13 and a second interactive connection 15. The first interactive connection 13 interfaces with the interactive connection 11 on the production facility 12, from where is applied the individual song elements that comprises the review song 14.

The website 16, as shown in FIG. 2, has a first interactive connection 17 a second interactive connection 19, a third interactive connection 21, and a fourth interactive connection 23, wherein the first interactive connection 17 interfaces with the second interactive connection 15 on the review song 14. The website provides:

(1) choices pertaining to least one review song 14, and the ability to select from the choices,

(2) means for delivery of the final product 22,

(3) means for archiving/storing and retrieval of the final product.

The choices pertaining to the song elements are selected from the group consisting of, but not limited to, at least two intros, verses, choruses, bridges, solos, chord progressions, melodies, riffs and sets of lyrics.

The review song 14 and the website interactive connections are comprised of a digital data transfer protocol that is selected from the group consisting of a modem, a dial-up service, digital cable, a mobile connection, a satellite connection, a set up box, a DVR and PVR.

The means for delivery of the final product is selected from the group consisting of but not limited to, real-time or no real-time streaming or playback of digital material to computers, laptops, mobile devices, cell phones, iPods, iPhones, AppleTV, IPTV, Set-Top Boxes (STB), eHome Networks, Internet, Cable, Satellite, Radio, Satellite Radio, Video Game Systems, Mobile Game Systems, Massively Multiplayer Online Game Environment (MMOG), Massively Multiplayer Online Role Play Game Environments (MMORPG), 2-way radio, microwave, WiFi, WiMax, LTE, Infrared, Laser, RFID, Fiber Optics, PVR, DVR, VoD, CD-R, CDRW, DVD, DVD+/−RW, HD-DVD, Blu-Ray Disc, Videotape, P2, SDRAM.

The means for archiving/storing and retrieval of the final product is selected from the group consisting, of, but not limited to, real-time or non-real-time streaming or playback of digital material to computers, laptops, mobile devices, cell phones, iPods, iPhones, AppleTV, IPTV, Set-Top Boxes (STB), eHome Networks, Internet, Cable, Satellite, Radio, Satellite Radio, Video Game Systems, Mobile Game Systems, Massively Multiplayer Online Game Environments (MMOG), Massively Multiplayer Online Role Play Game Environments (MMORPG), 2-way radio, microwave, WiFi, WiMAX, LTE, Infrared, Laser, RFID, Fiber Optics, PVR, DVR, VoD, CD-R, CDRW, DVD, DVD+/−RW, HD-DVD, Blu-Ray Disc, Videotape, P2, SDRAM, ROM and CD-ROM.

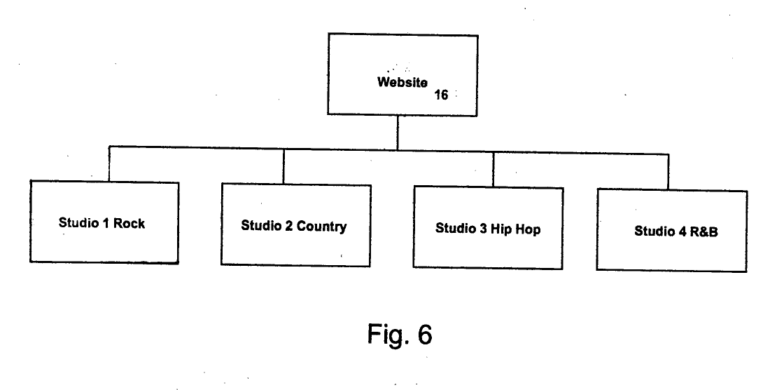

The website 16 can also include multiple studios, with each studio specializing in, or assigned, a particular type of music. For example, as shown in FIG. 6, a studio 1 can be assigned Rock Music; a studio 2 can be assigned Country Music; a studio 3 can be assigned Hip Hop Music; and a studio 4 can be assigned R&B music.

The website 16 can also be designed to function in combination with Social Networking-Forums for users to BLOG or write opinions and a music destination. The music destination provides access to a full music library of artists, the ability to download audio and video, purchase music and merchandise, create personal play lists and access Internet links to other websites for additional products and information.

The website host 18, as shown in FIG. 2, has an interactive connection 25 that interfaces with the second interface connecting 19 on the website 16. The website host is centrally located to control and manage the operation of the elements comprising the business model 10.

The website access 20 has an interactive connection 27 that interfaces with the third interactive connection 21 on the website, wherein the website access provides the ability for the general public to onto the website 16, as shown in FIG. 2.

The final song 22 has an interactive connection 29 that interfaces with the fourth interactive connection 23 located on the website 16. The final song is developed from the choices selected on the website and is delivered via the fourth interactive connection 23.

The final element that comprises the second embodiment of the business model 10 is the revenue generator, as shown in FIGS. 2 and 5. The means for generating revenue is selected from the group consisting of, but not limited to, advertising merchandise, record labels, music/song creations, videos, royalties, studio charges, membership dues, and social networking.

While the invention has been described in detail and pictorially shown in the accompanying drawings it is not to be limited to such details, since many changes and modifications may be made to the invention without departing from the spirit and the scope thereof. For example, advances in content distribution, content sharing, content consumption, content development, digital rights management (DRM), and digital asset management (DAM) are anticipated to continue to develop and advance as new technologies are developed in the coming years. Hence, it is described to cover any and all modifications and forms which may come within the language and scope of the claims.

1. A business model for interactive development of a product, said business model comprising:
a) a production facility (12) having:
(1) an interactive connection (11), and
(2) means for producing at least one review product (14) and a final product (22),
b) a website (16) having a first interactive connection (17), a second interactive connection (19), a third interactive connection (21) and a fourth interactive connection (23), wherein the first interactive connection (17) interfaces with the . interactive connection (11) on said production facility (12), wherein said. website provides:
(1) choices pertaining to said at least one review product (14), and the ability to select from said choices,
(2) means for delivery of said final product (22),
(3) means for storage and retrieval of said final product,
c) a website host (18) having an interactive connection (25) that interfaces with the second interactive connection (19) located on the website (16), wherein said website host is centrally located to control and manage the operation of said website,
d) a website access (20) having an interactive connection (27) that interfaces with the third interface connection (21) on said website (16), wherein said website access (20) allows the public to log onto said website (16) and provides:
(1)the ability to view and hear said at least one review product (14) and said choices,
(2) the ability to interactively select from said choices, and
(3) the ability to view and listen to said final product (22), and
e) a revenue generator (24) having an input connection (33) that interfaces with the fourth interactive connection (23) located on the website (16), and having means for generating revenue derived from said final product (22).

2. The business model for interactive development of a product as specified in claim 1 wherein said production facility is selected from the group consisting of a music studio, a film studio, a television studio, a vehicle design studio, and a sports development center.

3. The business model for interactive development of a product as specified in claim 1 wherein said final product is selected from the group consisting of a song, a film, a sport application, a vehicle, a food and an article of manufacture.

4. The business model for interactive development of a product as specified in claim 3 wherein said article of manufacture is selected from the group consisting of a tool, an electronic device, and an electrical device.

5. The business model for interactive development of a product as specified in claim 1 wherein said product is a film, the film choices are selected from the group consisting of major studios, independent studios, animation studios, writers, directors, producers, visual effects companies, art directors, and film directors movie and stage stars, aid, co-stars, visual effects, music, dialogue and soundtracks of live-action or animated films.

6. The business model for interactive development of a product as specified in claim 1 wherein when said product is a sport application, the sport choices are selected from the group consisting of: sport clubs, sport teams, sport team owners, sport team management and athletes that are selected by viewing and evaluating their respective performances.

7. The business model for interactive development of a product as specified in claim 1 wherein when said product is a vehicle, the vehicle choices are selected from the group consisting of: major car makers, designers, design studios, consumer research companies, and new automotive designs and features.

8. The business model for interactive development of a product as specified in claim 1 wherein when said product is a food, the food choices are selected from the group consisting of: food processors, restaurants, food television shows, gourmet chefs, growers, packaging companies, nutritionists and food research laboratories.

9. The business model for interactive development of a product as specified in claim 1 wherein said final product is comprised of a compilation of inputs provided by an original product creator and creative inputs that have been supplied to the product creator by the general public.

10. The business model for interactive development of a product as specified in claim 1 wherein said website is accessed by an interactive connection consisting of a digital data transfer protocol that is selected from the group consisting of a modem, a dial-up service, digital cable, broadband, broadcast, fiber, a mobile connections a satellite connection, a set-top box, a DVR, PVR and a VoD.

11. The business model for interactive development of a product as specified in claim 7 wherein said revenue generator is selected from the group consisting of advertising, merchandise, record labels, music/song creations, videos, royalties, studio charges, membership dues and social networking.

12. A business model for interactive development of a product comprising a song, said business model comprising:
a) a production facility (12) having:
(1) an interactive connection (11),
(2) the ability to develop and produce a plurality of elements pertaining to at least one review song, and
(3) the ability to develop and produce a final song (22),
b) a review song (14) having a first interactive connection (13) and a second interactive connection (15), wherein the first interactive connection (13) interfaces with the interactive connection (11) on said production facility (12) from where is applied the individual song elements that comprise said review song,
c) a website (16) having a first interactive connection (17), a second interactive connection (19); a third interactive connection (21), and a fourth interactive connection (23), wherein the first interactive connection (17), interfaces with the second interactive connection (15) on said review song, wherein said website provides:
(1) choices pertaining to said at least one review product (14), and the ability to select from said choices,
(2) means for delivery of said final product (22),
(3) means for an archiving/storing and retrieval of said final product,
d) a website host (18) having an interactive connection (25) that interfaces with the second interface connection (19) on said website (16), wherein said website host is centrally located to control and manage the operation of the elements comprising said business model,
e) a website access (20) having an interactive connection (27) that interfaces with the third interactive connection (21) on said website (16), wherein said website access provides the ability for the general public to log onto said website,
f) a final product consisting of the final song (22) having an interactive connection (29) that interfaces with fourth interactive connection (23) located on said website (16), and an output connection (31), wherein said final song is developed from the choices selected on said website, and is delivered via the fourth interactive connection (23), and
g) a revenue generator (24) having an input connection (33) that interfaces with the final song (22) from the output connection (31), said revenue generator having means for generating revenue from said final song.

13. The business model for interactive development of a product as specified in claim 12 wherein said production facility is comprised of a music studio for the production of rock, country, hip hop, R&B and classical music, a television studio or a radio station, vehicle design studio and a sport development center.

14. The business model for interactive development of a product as specified in claim 12 wherein said choices pertaining to said song elements are selected from the group consisting of at least two: intros, verses, choruses, bridges, solos, chord progressions, melodies, and sets of lyrics.

15. The business model for interactive development of a product as specified in claim 12 wherein said review song (14) and said website (16) first interactive connections are comprised of a digital data transfer protocol that is selected from the group consisting of a modem, a dial-up service, digital cable, broadband, broadcast, fiber, a mobile connection, a satellite connection, a set-up box, a DVR, PVR and a VoD.

16. The business model for interactive development of a product as specified in claim 12 wherein said means for delivery of said final product is selected from the group consisting of: real-time or non-real-time streaming or playback of digital material to computers, laptops, mobile devices, cell phones, iPods, iPhones, AppleTV., IPTV, Set-Top Boxes (STB), eHome networks, Internet, cable, satellite, radio, Satellite Radio, Video Game Systems, Mobile Game Systems, Massively Multiplayer Online Game Environments (MMOG), Massively Multiplayer Online Role Play Game Environments (MMORPG), 2-way radio, microwave, WiFi, WiMax, LTE, Infrared, Laser, RFID, Fiber Optics, PVR, DVR, VoD; CD-R, CDRW, DVD, DVD+/−RW, HD-DVD, Blu-Ray Disc, Videotape, P2, SDRAM, ROM and CD-ROM.

17. The business model for interactive development of a product as specified in claim 12 wherein said means for archiving/storing and retrieval of said final product is selected from the group consisting of real-time or non-real-time-streaming or playback of digital material to computers, laptops, mobile devices, cell phones, iPods, AppleTV, IPTV, Set-Top Boxes (STB), eHome Networks, Internet, cable, Satellite, radio, Satellite Radio, Video Game Systems, Mobile Game Systems, Massively Multiplayer Online Game Environments (MMOG), Massively Multiplayer Online Role Play Game Environments (MMORPG), 2-way radio, microwave, WiFi, WiMAX, LTE, Infrared, Laser, RFID, Fiber Optics, PVR, DVR, VoD, CD-R, CDRW, DVD, DVD+/−RW, HD-DVD, Blu-Ray Disc, Videotape, P2, SDRAM, ROM and CD-ROM.

18. The business model for interactive development of a product as specified in claim 12 wherein said website further comprises Social Networking Forums for users to BLOG or write opinions and a music destination that provides access to a full music library of artists, the ability to download audio and video, purchase music and merchandise, create personal play lists and access Internet links to other websites for

19. The business model for interactive development of a product as specified in claim 12 wherein said means for generating revenue is selected from the group consisting of the sale of advertising .web space, merchandise revenue sharing, sales of music or videos, record labels, studio charges, music/song creation revenue sharing, social networking and royalties.
